(19) United States
(12) Patent Application Publication
(10) Pub. No.: US 2006/0232527 A1
(43) Pub. Date: Oct. 19, 2006

(54) Apparatus for receiving monitor for vehicles

(75) Inventor: Chang-Jong Oh, Kyungki-do (KR)

Correspondence Address: AKERMAN SENTERFITT, P.O. BOX 3188, WEST PALM BEACH, FL, 33402-3188, US

(73) Assignee: KMC Co., Ltd., Kyungki-do (KR)

(21) Appl. No.: 10/552,406

(22) PCT Filed: Apr. 6, 2004
(86) PCT No.: PCT/KR04/00789

§ 371 Date: Oct. 7, 2005

(30) Foreign Application Priority Data
Apr. 9, 2003 (KR) 2020030010749
Apr. 9, 2003 (KR) 2020030010750
Oct. 8, 2003 (KR) 2020030031606

(51) Int. Cl. G09G 3/36; G06F 1/16

(52) U.S. Cl. 345/87; 361/681

(57) ABSTRACT

An apparatus for receiving a television or a navigator display monitor for vehicles which can easily and automatically regulate a horizontal angle of a monitor mounted therein. The apparatus comprises a chassis panel (5) having synthetic resin sliders positioned at both sides thereof, a tilting body (1) being connected to a monitor cover frame (3), a driving motor (6, 16) provided at the tilting body 1 and a gear train (7, 8, 19, 21, 22) for reducing speed of the driving motor (6, 16), a pivoting plate (23) having a pivoting gear (24) rotated by the driving motor (16), and a pair of rotating shafts (31) being rotatably installed to the tilting body (1).

### TECHNICAL FIELD

The invention relates to an apparatus for receiving a television or a navigator display monitor for vehicles, more particularly to an apparatus for receiving a television or a navigator display monitor for vehicles for automatically regulating an angle of the monitor for a navigator or a television which is ejected from a casing mounted at an instrument panel (or a dash board) and then is stood, by simple operation.

### BACKGROUND ART

Generally, in the apparatus for receiving a television or a navigator display provided at vehicles, the Liquid Crystal Display (LCD) monitor for a navigator or a television is ejected/received from/into a case mounted at an instrument panel or a dash board of vehicles in a slide manner. The size of the monitor is standardized internationally.

The conventional television or navigator display monitor receiving apparatus as above described, however, has a disadvantage that a horizontal angle regulation of the monitor is only carried out manually since the monitor is automatically regulated in vertical direction but not in horizontal direction.

Also, when the monitor is ejected/received from/into the case, because guide rails for guiding a chassis panel are positioned under the case having a standard size, the conventional television or navigator display monitor receiving apparatus has a disadvantage that the conventional television or navigator display monitor receiving apparatus used in vehicles has no a space for mounting devices such as MPEG board, DVD servo-board, printed circuit board, and amplifier using LCD.

### DISCLOSURE OF INVENTION

Therefore, an object of the present invention is to provide an apparatus for receiving a television or a navigator display monitor for vehicles which can easily and automatically regulate a horizontal angle of a monitor mounted therein so that user can easily witch the monitor for a navigator or a television.

Another object of the present invention is to provide an apparatus for receiving a television or a navigator display monitor for vehicles having a space for mounting devices such as MPEG board, DVD servo-board, printed circuit board, and amplifier using LCD.

The objects can be accomplished by an apparatus for receiving a television or a navigator display monitor for vehicles according to an embodiment of the present invention, in which a liquid crystal monitor is ejected/received from/into a case in slide manner while is tilted in horizontal direction when the monitor is ejected from the case, the apparatus comprises:

a chassis panel having synthetic resin sliders positioned at both sides thereof, the sliders being slid along guide rails mounted to inner sides of the case;

a tilting body being connected to a monitor cover frame to which a monitor cover is mounted and being tilted in horizontal direction along a pair of teethed slots formed at the chassis panel;

a driving motor provided at the tilting body and a gear train for reducing speed of the driving motor;

a pivoting plate having a pivoting gear rotated by the driving motor and being rotatably mounted at the tilting body to be pivoted in the rotation direction of the pivoting gear; and

a pair of rotating shafts being rotatably installed to the tilting body and having a upper gear engaged with a teethed portion of the teethed slots and a lower gear engaged with intermediate gears installed to both sides of the tilting body, while engaged with the pivoting gear when the pivoting plate is pivoted, respectively.

The gear train includes a worm gear mounted to a shaft of the driving motor, a helical gear engaged with the worm gear, and a small gear formed integrally with the helical gear and engaged with the pivoting gear.

Preferably, the pivoting plate has a bent piece being guided along an arc guide slot formed at the tilting body.

The teethed portion is only formed at an inside edge of the teeth slot.

The guide rails have a protector made from synthetic resin at front end thereof, respectively.

Also, the objects can be accomplished by an apparatus for receiving a television or a navigator display monitor for vehicles according to another embodiment of the present invention, in which a liquid crystal monitor is ejected/received from/into a case in slide manner while is tilted in horizontal direction when the monitor is ejected from the case, the apparatus comprises:

a chassis panel being connected to a monitor cover frame to which a monitor cover is mounted and having a pair of L shaped teethed slots having teethed edge and a plurality of support and guide slots, the monitor cover having straight portions connected to guide rails of the case in straight line when the monitor cover frame is disposed horizontally;

a tilting body having a plurality of pins supported at several points and guided by the support and guide slots and being pivoted about imaginary centers when the tilting body is tilting by driving of a driving motor provided inside thereof; and

a pair of clutch mechanisms including a lower clutch shaft driven by the driving motor, an upper clutch shafts having upper gears engaged with the teethed edges and frictionally coupled to the lower clutch shaft, and a spring for pressing the lower clutch shaft against the upper clutch shaft, respectively;

wherein the upper gears of clutch mechanisms rotate in a same direction.

The lower clutch shaft has serration grooves formed at an upper surface thereof, the upper clutch shaft has serration grooves frictionally coupled to the serration grooves of the lower clutch shaft by the spring, at lower surface thereof.

Preferably, the support and guide slot is positioned at central portion of the chassis panel and is formed V-shape of which each side has a certain curvature.

The teethed portions are only formed at an outside edge of the teeth slots.

### BRIEF DESCRIPTION OF THE DRAWINGS

Further objects and advantages of the invention can be more fully understood from the following detailed description taken in conjunction with the accompanying drawings, in which:

FIG. 1 is a bottom view showing an apparatus for receiving a television or a navigator display monitor for vehicles according to the present invention.

FIG. 2 is a side view of the apparatus for receiving a television or a navigator display monitor for vehicles as shown in FIG. 1.

FIG. 3 is a bottom view showing an apparatus for receiving a television or a navigator display monitor for vehicles according to a first embodiment of the present invention.

FIG. 4 is a bottom view showing a state in which a monitor cover frame is tilted in a direction, in the apparatus as shown in FIG. 3.

FIG. 5 is a perspective view approximately showing a tilting body in the apparatus according to the present invention.

FIG. 6 is a bottom view showing an apparatus for receiving a television or a navigator display monitor for vehicles according to a second embodiment of the present invention.

FIG. 7 is a perspective view approximately showing a tilting body in the apparatus as shown in FIG. 6.

FIG. 8 is a cross-sectional view a clutch mechanism provided at the apparatus as shown in FIGS. 6 and 7.

FIG. 9 is a view a state in which a monitor cover frame is tilted in a direction, in the apparatus as shown in FIGS. 6 and 7.

### BEST MODE FOR CARRYING OUT THE INVENTION

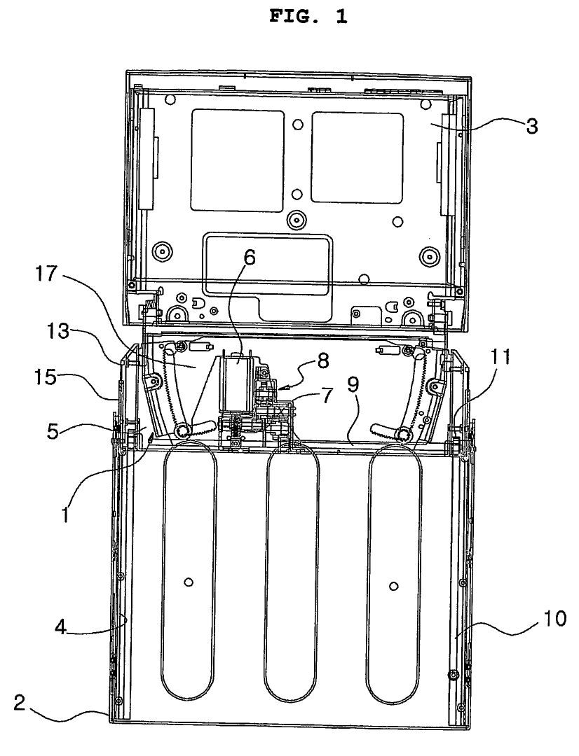

FIG. 1 is a bottom view showing an apparatus for receiving a television or a navigator display monitor for vehicles according to the present invention. As shown in FIG. 1, in the apparatus according to the present invention, a tilting body 1 is mounted to a chassis panel 5 which is connected to a case 2. The tilting body 1 has a lower plate formed with a cut portion through which a loading motor 6 is mounted to the chassis panel 5. When the loading motor 6 is driven, a speed of the loading motor 6 is reduced by a group of gear train 8 engaged with a worm gear 7 provided at a shaft of the loading motor 6. The reduced rotation of the loading motor 6 is transferred to a rotation shaft 9 through the gear train 8, the rotation shaft 9 is rotatably installed to the chassis panel 5. A pair of gears 11 are provided at both ends of the rotation shaft 9 and engaged with a rack gear 10 fixed to an upper surface of the case 2. Therefore, the rotation shaft 9 is driven, the gears 11 are rolled on the rack gear 10 such that the chassis panel 5 is ejected/received from/into the case 2.

As shown in FIG. 1, the chassis panel 5 is connected to a monitor cover frame 3. Therefore, the monitor cover frame 3 can be ejected/received from/into the case 2 as the chassis panel 5 moves in the driving direction of the loading motor 6. When the chassis panel 5 moves by the driving of the loading motor 6, synthetic resin sliders 13 provided at both sides of the chassis panel 5 are slid along guide rails 4 mounted to both inner sides of the case 2.

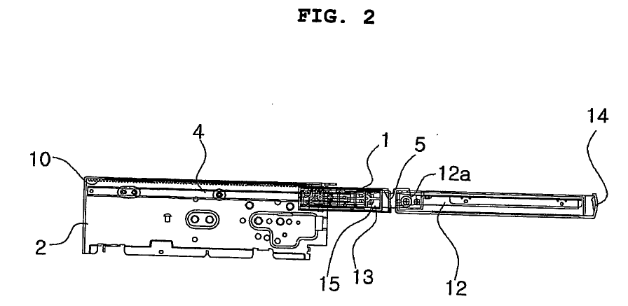

As known from FIG. 2, a monitor cover 14 mounted to the monitor cover frame 3 has straight recessed portions 12 at both sides thereof, the guide rails 4 is smoothly fitted into the straight recessed portions 12 when the monitor cover frame 3 is received into the case 2 after the sliders 13 are slid along the guide rails 4, whereby the monitor cover 14 ejects/enters from/into the case 2 without playing, and the monitor cover 14 can be prevented from playing in the case 2 when the monitor cover 14 is received in the case 2. The width of the straight recessed portions 12 is slightly larger than the guide rails 4 and an inner end portion 12a of the straight portion 12 has an extended shape. Also, the straight portion 12, sliders 13, and the guide rails 4 are disposed on a straight line when the monitor cover frame 3 is ejected from the case 2. Therefore, when the monitor cover frame 3 is being received into the case 2, the guide rails 4 can be smoothly and reliably fitted into the straight recessed portions 12.

When the monitor cover 14 made from synthetic resin is received into the case 2, the straight portion 12 may be damaged by contacting with the guide rails 4 made from metal such as steel. In order to prevent the straight portion 12 from damaging by contacting with the guide rails 4, protect members 15 made from synthetic resin are provided at ends of the guide rails 4, respectively. The hardness of the protect members 15 is same as the monitor cover 14 or is lees than it. Therefore, accordingly to the present invention, when the monitor cover 14 ejects/enters from/into the case 2, the straight portion 12 can be damaged by contacting with the guide rails 4 made from metal such as steel.

As described above, the sliders 13 provided at both sides of the chassis panel 5 are slidingly coupled to the guide rails 4 while the monitor cover 14, which is mounted to the monitor cover frame 3 connected to the tilting body 1 provided in the chassis panel 5, is guided by the guide rails 4 when the monitor cover 14 ejects/enters from/into the case 2. A certain sized space is formed under the monitor cover 14 when the monitor cover 14 is received in the case 2. Devices such as MPEG board, DVD servo-board, printed circuit board, and amplifier using LCD are mounted in the space.

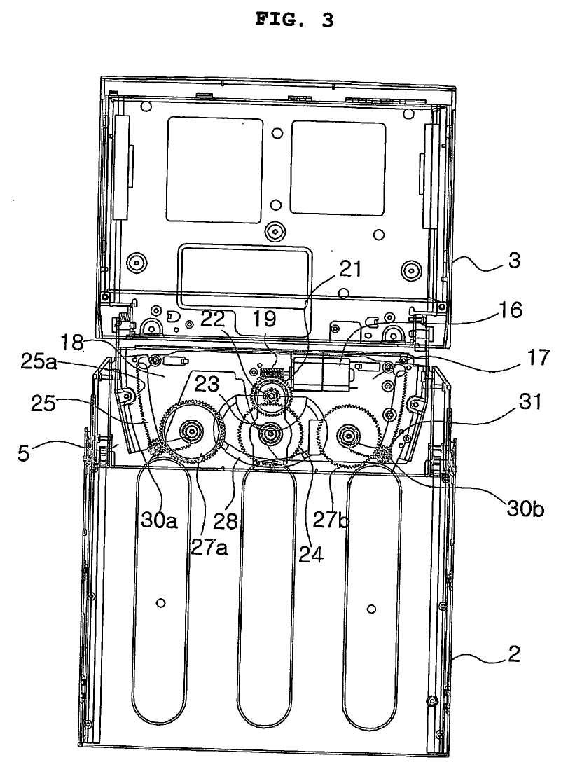

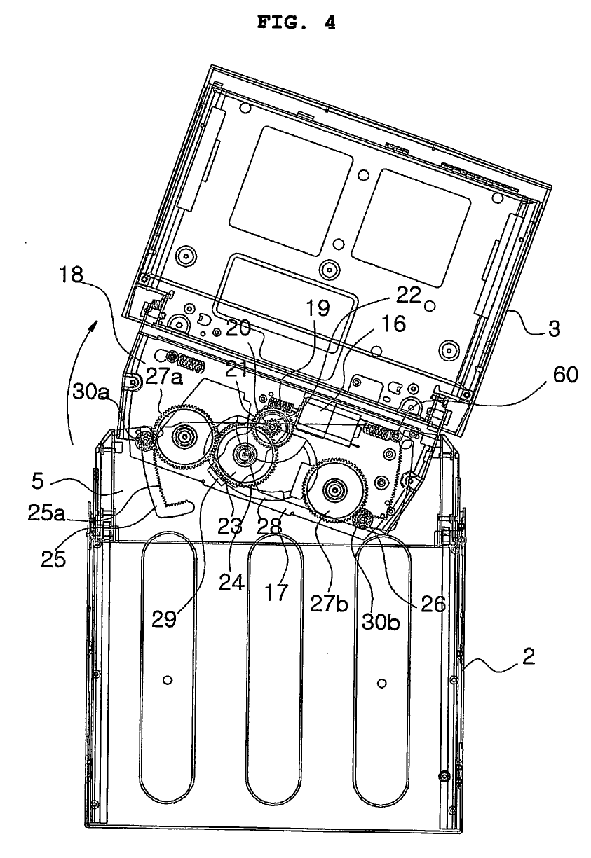

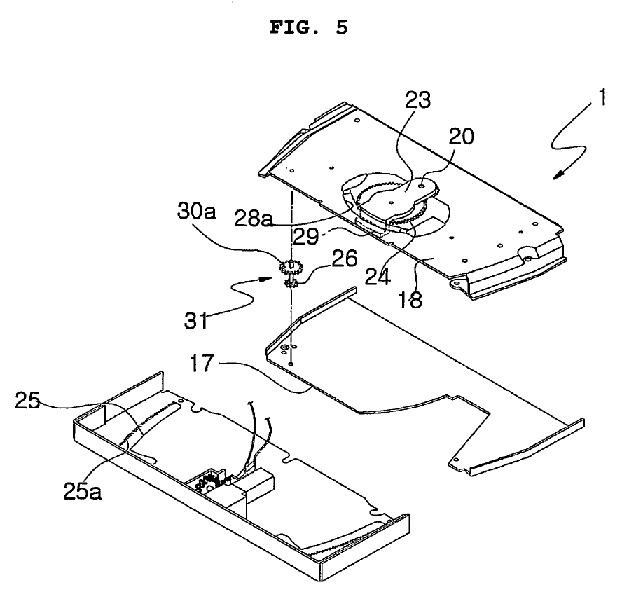

As shown in FIGS. 3 to 5, a motor 6 for tilting the monitor cover frame 3 is provided at the tilting body 1. The tilting body 1 is connected to the monitor cover frame 3 and is tilted along with the monitor cover frame 3, as described above. Inner both sides of the tilting body 1 are rounded to prevent contacting with sides of the chassis panel 5 when the tilting body is tilted from side to side, as known from FIG. 5. The tilting body 1 has an upper plate 17 adjacent to the chassis panel 5 and a lower plate 18 opposing to the upper plate 17.

A driving motor 16 provided at the tilting body 1 has a motor shaft to which a worm gear 19 is installed. The worm gear 19 is engaged with a helical gear 21 rotatably supported to a shaft 20 provided at the tilting body 1. The helical gear 21 is formed integrally with a small gear 22 at lower portion thereof (in the drawing) as shown in FIG. 3. A pivoting plate 23 is installed to an end of the shaft, which is passing through the lower plate 18 of the tilting body 1, such that the pivoting plate 23 can be pivoted about the shaft 20. In the pivoting plate 23, a pivoting gear 24 is rotatably provided. The pivoting gear 24 is engaged with the small gear 22 and is disposed at a central recessed portion of the lower plate 18 of the tilting body 1. Therefore, when the driving motor 16 is driven, the pivoting gear 24, which is rotatably installed to a lower portion of the pivoting plate 23, is rotated by the rotation of the small gear 22, and then the rotation of the pivoting gear 24 is transferred to the pivoting plate 23 so that the pivoting plate 23 is pivoted about the shaft 20 in the driving direction of the driving motor 16.

The pivoting plate 23, as detail shown in FIG. 5, has a bent piece 29 formed at edge thereof which is put in an arc guide slot 28 in the lower plate 18. as described above, when the pivoting plate 23 is pivoted, an outer surface of the bent piece 29 is guided along the arc guide slot 28, while the bent piece 29 is contacted with an outer edge 28a of the arc guide slot 28.

As described above, when the pivoting plate 23 is pivoted by driving of the driving motor 16 in one direction, the pivoting gear 24, which is rotatably installed to the pivoting plate 23, is pivoted in one direction along with the pivoting plate 23, and then the pivoting gear 24 is engaged with one 27a of a pair of intermediate gears 27a, 27b, the intermediate gears 27a, 27b are rotatably installed to the lower plate 18 of the tilting body 1. The intermediate gears 27a, 27b are protruded toward the pivoting gear 24 through cut portions at both sides of the recessed portion in which the pivoting gear 24 is disposed.

As the pivoting plate 23 is pivoted about the shaft 20 in one direction, as described above, if the pivoting gear 24 is engaged with one 27a of a pair of intermediate gears 27a and 27b, the pivoting of pivoting plate 23 about the shaft 20 is stopped. At this time, the driving force of the driving motor 16 is transferred to the intermediate gear 27a through the small gear 22 integrally formed with the helical gear 21 and the pivoting gear 24 engaged with the small gear 21. On the one hand, the intermediate gears 27a and 27b are engaged with a lower gear 30a formed at one of rotating shafts 31, which are rotatably supported between the upper and the lower plates 17 and 18 of the tilting body 1, respectively. Each of rotating shafts 31 has the lower gear 30a adjacent to the lower plate 18 and an upper gear 26 moving along teeth slots 25 formed at the chassis panel 5.

Each teeth slot 25 formed at the chassis panel 5 is formed in L shape having rounded sides and is formed with a teethed portion 25a at inside or outside edge thereof, preferably at inside edge. The upper gear 26 of each rotating shaft 31 is engaged with the teethed portion 25a of the teeth slot 25.

The driving force of the pivoting gear 24 is transferred to the rotating shafts 31 through the intermediate gears 27a and 27b. Therefore, the upper gears 26 provided at the rotating shaft 31 are rotated, so that the upper gears 26 are moved along the teeth slots 25 formed at the chassis panel 5. Because the upper gears 26 are moved along the teeth slots 25 and the rotating shaft 31 are installed to the tilting body 1, the tilting body 1 is tilted in one direction about the pivoting point on which the tensile force of an extension spring acts.

On the one hand, because the upper gears 26 are pressed against the upper plate 17 by a compress spring (not shown) provided at the rotating shaft 31, contacting between the tilting body 1 and the chassis panel 5 are continuously maintained, so that the upper gear 26 can be surely engaged with the teethed portion 25a of the teeth slot 25, and also by the compress spring, playing between the tilting body 1 and the chassis panel 5 is prevented to thereby avoid noise due to the playing.

As described above, if the driving force of the driving motor 16 is transferred to one of two upper gears 26, one upper gear 26 is moved outwardly along one teeth slot 25, the other upper gear (not shown) is moved inwardly along the other teeth slot 25, as shown in FIG. 1. When the upper gears 26 are moved along the teeth slots 25, the tilting body 1 is tilted about the pivoting point 60 in moving direction of the upper gears 26 by the moving of the upper gears 26.

When the upper gears 26 are moved along the teeth slots 25, slip is prevented from generating between the upper gears 26 and the teeth slots 25, since the upper gears 26 are engaged with the teethed portion 25a of the teeth slots 25. Therefore, the upper gears 26 can surely move along the teeth slots 25 without slip. When the upper gears 26 arrive in the tilting position along the teeth slots 25, the driving of the driving motor 16 is stopped by actuating of limit switch (not shown) and the monitor cover frame 3 is positioned at the tilting position of the tilting body 1. Accordingly, user can easily watch the display monitor (not shown) provided at the monitor cover frame 3.

The monitor should be returned the position shown in FIG. 3 from the monitor watching position, in order that the monitor is received into the case 2. For this reason, the driving motor 16 is a reversible motor which can rotate in the other direction by an operation of a switch for the driving motor 16. The pivoting plate 16 is pivoted in the other direction about the shaft 20 by the pivoting gear 24 rotated in the other direction when the driving motor 16 is driven in the other direction.

As pivoting plate 16 is pivoted in the other direction about the shaft 20, as described above, the pivoting gear 24 provided at the pivoting plate 23 is engaged with the other intermediate gear 27b. Therefore, the driving force of the driving motor 16 is transferred to the other intermediate gear 27b. Because the other intermediate gear 27b is engaged with the lower gear 30b of the other rotating shaft 30, the upper gears 26 of the rotating shafts 30 are moved in the other direction along the teeth slots 25.

Therefore, the tilting body 1 is returned to the initial position as the upper gears 26 are moved along the teeth slots 25 formed at the chassis panel 5. When the tilting body 1 arrives in the initial position, another limit switch (not shown) is actuated, so that the driving of the driving motor 16 is stopped, and then the tilting body 1 can be received into the case 2 at the position as shown in FIG. 3.

That is, when the tilting body 1 is positioned at the position as shown in FIG. 3, there is driven a motor (not shown) for receiving the monitor cover frame 3 into the case 2 such that the monitor cover frame 3 is received in the case 2 together with the chassis panel 5 and the tilting body 1.

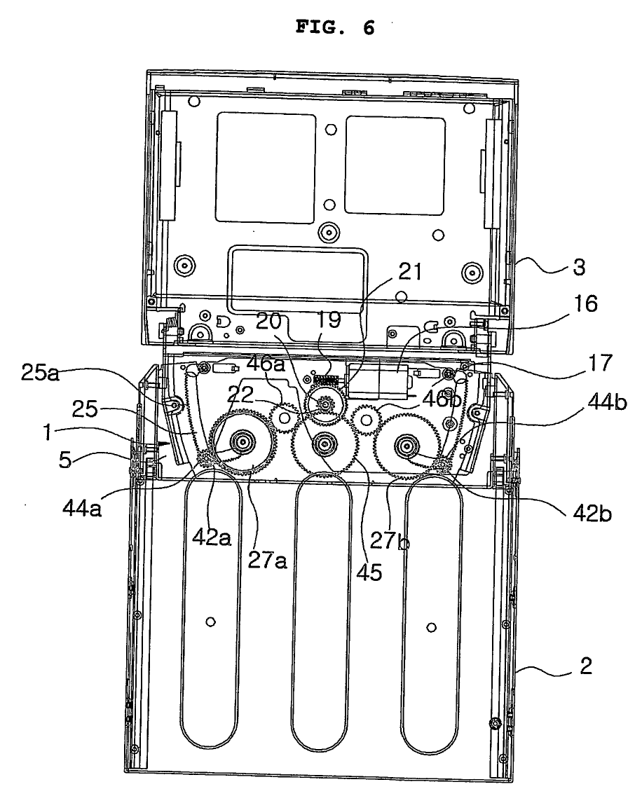

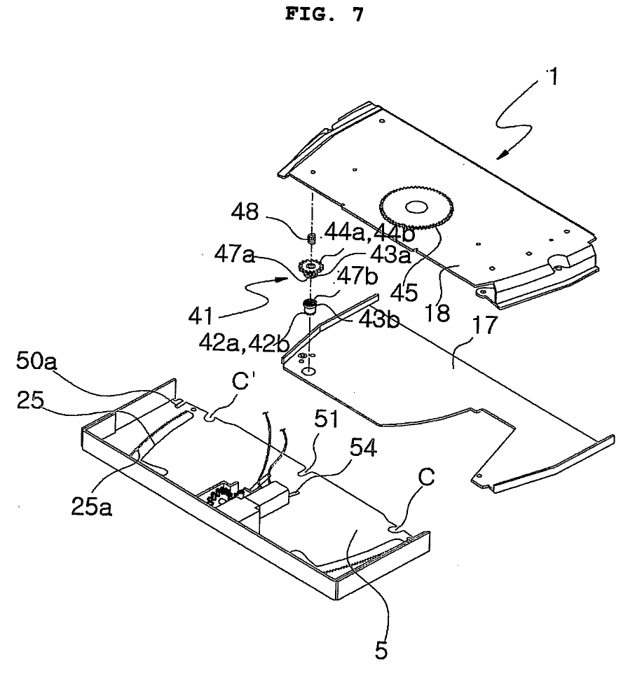

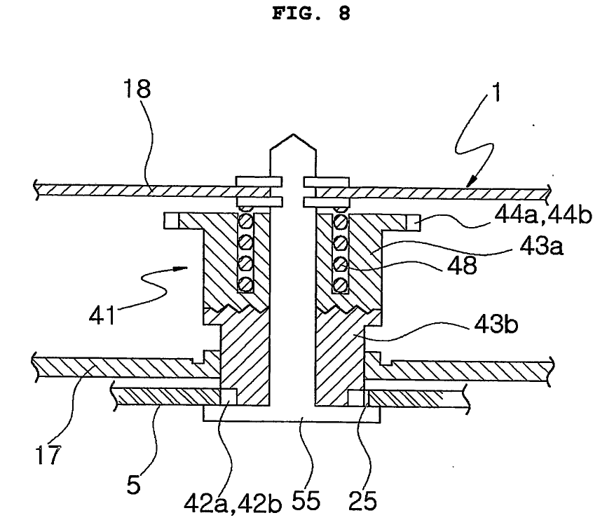

As shown in FIGS. 6 to 9, in an apparatus for receiving a television or a navigator display monitor for vehicles according to a second embodiment of the present invention, a pair of intermediate gears 27a and 27b are connected to a central gear 45 and are rotatably mounted to clutch mechanisms 41 which are rotatably installed to the tilting body 1 (see FIG. 7). The clutch mechanisms 41 include a lower clutch shaft 43a driven by the driving motor 16, an upper clutch shafts 43b having upper gear 42a, 42b engaged with the teethed edge 25a of teethed slots 25 and frictionally coupled to the lower clutch shaft 43a, and a spring 48 for pressing the lower clutch shaft 43a against the upper clutch shaft 43b, respectively. Lower gears 44a, 44b provided at each of lower clutch shafts 43a are rotated in a same direction by rotation direction keeping gears 46a, 46b which are is for connecting the central gear 45 with the intermediate gears 27a and 27b. Of course, the upper gears 42a, 42b, that is, the lower gears 44a, 44b are rotated in a same direction, in case the driving force of the central gear 45 is directly transferred to the intermediate gears 27a and 27b without using of the rotation direction keeping gears 46a, 46b.

As shown in FIG. 7, lower surfaces of the upper clutch shafts 43b are frictionally coupled to upper surfaces of the lower clutch shafts 43a by the springs 48. The lower surfaces of the upper clutch shafts 43b and the upper surfaces of the lower clutch shafts 43a have serration grooves 47a, 47b to provide larger friction area therebetween. Accordingly, the lower clutch shafts 43a are frictionally coupled to the upper clutch shafts 43b by the springs 48 having a smaller compresses force which is supported by the lower plate 18.

By the serration grooves 47a, 47b, the rotation of the lower clutch shafts 43a is surely transferred to the upper clutch shafts 43b, and when a larger external force than the force of springs 48 acts on the tilting body 1, slip is occurred between the lower clutch shafts 43a and the upper clutch shafts 43b to intercept transferring the rotation force to the upper clutch shafts 43b from the lower clutch shafts 43a, so that parts such as gears can be prevented from damaging by the external force.

As described above, the driving force of the driving motor 16 is transferred to the upper clutch shafts 43b through each of lower clutch shafts 43a and the upper gears 42a, 42b are provided at upper portion of the upper clutch shafts 43b. The upper gears 42a, 42b are engaged with the teethed portion 25a at the teeth slots 25 formed in the chassis panel 5. Because the chassis panel 5 is fixed to the case 2 as shown in FIG. 6, as the driving force is transferred to the upper clutch shafts 43b from the lower clutch shafts 43a, the upper gears 42a, 42b are moved along the teeth slots 25 formed in the chassis panel 5. Therefore, the tilting body 1 is pivoted in the rotation direction of the upper gears 42a or 42b about an imaginary center C or C′ (see FIG. 7). On the one hand, the teethed edges 25a are formed at inside or outside of each of teethed slots 25, but it is preferable that the teethed edges 25a are formed at outside of each of teethed slots 25 to surely engage with the upper gears 42a, 42b during the tilting of tilting body 1, as shown in drawings, since the tilting body 1 tends to move outwardly by rotation thereof.

Since the teethed slots 25 having the teethed edge 25a engaging with the upper gears 42a, 42b are formed into L shape and the upper gears 42a and 42b rotate about an imaginary center C or C′ during the tilting of tilting body 1, a long and a short sides of the teethed slots 25 must have a same curvature.

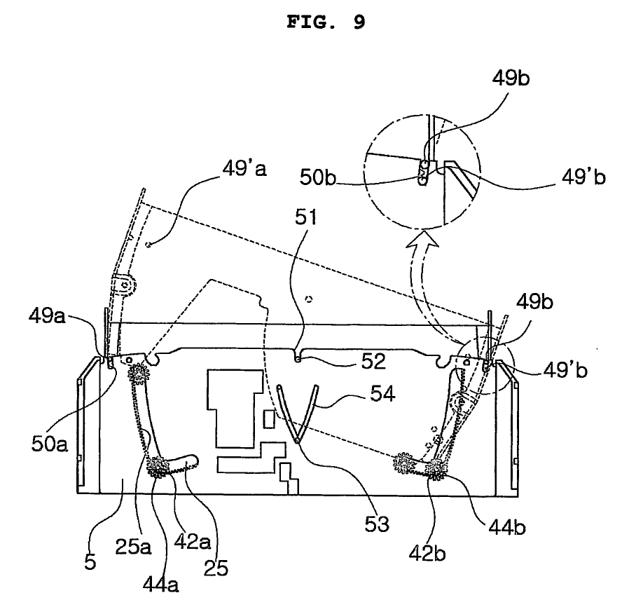

Referring to FIG. 9, the tilting movement of tilting body 1 will be described in detail. The tilting body 1 is provided with first guide pins 49a, 49b which are protruded upwardly at both sides of upper portion of the upper plate 17 adjacent to the chassis panel 5. At an initial position as shown by a solid line at FIG. 9, the first guide pins 49a, 49b are disposed in arc shaped passages 50a, 50b, respectively, which are formed at both sides of an entrance of the chassis panel 5. At initial position, the upper gears 42a, 42b are disposed at points, respectively, in which the long and the short sides of the L shape of teethed slots 25 meet.

As described above, when the tilting body 1 is tilting to the position as shown by a broken line at FIG. 9 about the imaginary center C by the driving of driving motor 16, one upper gear 42a moves along the long portion of one teethed slot 25 and the other upper gear 42b moves the short portion of the other teethed slot 25. Therefore, one first guide pin 49a moves to the point 49′a along the arc shaped passages 50a and the other first guide pin 49b moves to the point 49′b along the arc shaped passages 50b. At this time, the imaginary center C acts as a rotation center of the tilting body 1, that is, of the long portion of one teethed slot 25 and the short portion of the other teethed slot 25, according to the tilting movement of the tilting body 1. Because the upper gears 42a, 42b driven by the same driving force are disposed at difference distance from the imaginary center C which acts as a rotation center of the tilting body 1, the upper gears 42a, 42b have different driving force and different moving speed.

That is to say, since one upper gear 42a is disposed farther from the imaginary center C than the other upper gear 42b, a larger rotating force acts on one upper gear 42a than that of the other upper gear 42b. In addition, because one upper gear 42a moves the entire long portion and the other upper gear 42b moves the entire short portion, for a same time, a difference of moving speed generates between the upper gears 42a and 42b. That is, the speed of one upper gear 42a moving along the long portion of the teethed slot 25 is faster than that of the other upper gear 42b moving along the short portion of the teethed slot 25. Therefore, moment acting on one upper gear 42a disposed farther from the imaginary center C is larger than moment acting on the other upper gear 42b disposed near from the imaginary center C. Also, since same driving force is transferred to the lower gear 44a, 44b, which are coupled to the upper gear 42a, 42b, respectively, from the driving motor 16, slip is generated between the upper clutch shaft 43b provided with the other upper gear 42b and the lower clutch shaft 43a coupled to the upper clutch shaft 43b, due to differences of moment and moving speed.

In the meantime, since the upper gears 42a, 42b provided at the upper clutch shafts 43a are pressed against the upper plate 17 by the compress springs 48, which are installed to the lower clutch shafts 43a, respectively, the tilting body 1 is continuously contacted with the chassis panel 5 by the compress springs. Accordingly, the upper gears 42a, 42b can be surely engaged with the teethed edges 25a of the teethed slots 25 and playing can be prevented from occurring between the tilting body 1 and the chassis panel 5 by the compress springs 48, so that there can be prevented the occurring of noise due to playing of the parts.

As shown in FIGS. 7 and 9, a guide slot 54 having a certain curvature is provided at the chassis panel 5 for guiding the tilting movement of the tilting body 1. The guide slot 54 is preferably positioned to a central portion of the chassis panel 5 and has V shape in which each side has a certain curvature. A second guide pin 53 protruded upwardly from the upper plate 17 is fitted in the second guide slot 54 and is guided along the second guide slot 54 during tilting of the tilting body 1.

Further, the tilting body 1 has a round shape of recess 51 formed at outside central portion of the chassis panel 5, and there is fitted in the recess 51 a supporting pin 52 provided at upper surface of the upper plate 17. Therefore, at the initial position as shown by the solid line at FIG. 9, when the tilting body 1 is tilted toward a position as shown by the broken line about the imaginary center C, one upper gear 42a is supported and guided by the teethed edge 25a of the teethed slot 25, the first guide pin 49a is supported and guided by the arc shaped passages 50a, the second guide pin 53 is supported and guided by the guide slot 54, and the supporting pin 52 is supported and guided by the recess 51. Accordingly, the tilting body 1 is supported and guided by multi-points, so that the tilting body 1 can be tilted along an accuracy path. While the tilting body 1 is tilted, a jamming can be prevented from occurring between the tilting body 1 and the chassis panel 5 due to playing occurred between two members, so that the tilting body 1 can be tilted accurately.

On the one hand, since the upper gears 42a, 42b move along the teethed slots 25 in state that the upper gears 42a, 42b are engaged with the teethed edges 25a of the teethed slots 25, slip can be occurred between the upper gears 42a, 42b and the teethed edges 25a, so that the upper gears 42a, 42b can surely and accurately move along the teethed slots 25. When the upper gears 42a, 42b move to the tilting position along the teethed slots 25, the driving of driving motor 16 is stopped by an actuating of the limit switch (not shown) or microcomputer. The monitor cover frame 3 is positioned to the tilted position of tilting body 1 such that user can easily watch the display monitor (not shown) provided at the monitor cover frame 3.

From the monitor watching position as described above, the monitor must be returned to the position as show at FIG. 6 such that monitor is received in case 2. For this, the driving motor 16 is driven in another direction by actuating of a switch. According to this driving of driving motor 16, the tilting body 1 is tilted in opposing direction to the tilting direction of FIG. 9. At this time, the other imaginary center C′ acts as a rotation center of the tilting body 1, so that the tilting movement of the tilting body 1 is carried out about the other imaginary center C′. As the upper gears 42a, 42b move along the teethed slots 25, the tilting body 1 is returned to the initial position. When the tilting body 1 is positioned to the initial position, the driving of driving motor 16 is stopped by an actuating of other limit switch (not shown) or microcomputer. And then, the tilting body 1, that is, the monitor can be received into the case 2 from the initial position as shown in FIG. 6.

When the tilting body 1 is returned to the initial position, the tilting body 1 is accurately to the initial position, as the supporting pin 52 provided at upper surface of the upper plate 17 is guided by the recess 51 formed at outside central portion of the chassis panel 5. Since the recess 51 has rounded both outside portions, when the tilting body 1 is returned to the initial position, the supporting pin 52 can be easily fitted into the recess 51 by tilting movement of the tilting body 1.

As described above, when the tilting body 1 is positioned to the position as shown in FIG. 6, the driving motor for receiving the monitor cover frame into the case 2 is driven, so that the monitor cover frame 3 is received in the case 2 together with the chassis panel 5 and the tilting body 1.

By the an apparatus for receiving a television or a navigator display monitor for vehicles according to the present invention, the sliders provided at both sides of the chassis panel are slidingly coupled to the guide rails while the monitor cover, which is mounted to the monitor cover frame connected to the tilting body provided in the chassis panel, is guided by the guide rails when the monitor cover ejects/enters from/into the case. A certain sized space is formed under the monitor cover when the monitor cover is received in the case. Devices such as MPEG board, DVD servo-board, printed circuit board, and amplifier using LCD are mounted in the space. Accordingly, a space utilization coefficient of the case increases significantly in comparison with conventional display monitor receiving apparatus.

Also, when an external force is applied to the monitor case connected to the tilting body or the monitor, slip is occurred between clutch shafts, through which the driving force of the driving motor is transferred to the tilting body, due to the external force, the external force is not applied to other parts used for tilting the monitor by slip. Accordingly, parts for tilting can be prevented from damaging by the external force, according to the present invention.

What is claimed is:

1. An apparatus for receiving a television or a navigator display monitor for vehicles, in which a liquid crystal monitor is ejected/received from/into a case 2 in slide manner while is tilted in horizontal direction when the monitor is ejected from the case, the apparatus comprises:
a chassis panel 5 having synthetic resin sliders positioned at both sides thereof, the sliders 13 being slid along guide rails 4 mounted to inner sides of the case 2;
a tilting body 1 being connected to a monitor cover frame 3 to which a monitor cover 14 is mounted and being tilted in horizontal direction along a pair of teethed slots 25 formed at the chassis panel 5;
a driving motor 6, 16 provided at the tilting body 1 and a gear train 7, 8, 19, 21, 22 for reducing speed of the driving motor 6, 16;
a pivoting plate 23 having a pivoting gear 24 rotated by the driving motor 16 and being rotatably mounted at the tilting body 1 to be pivoted in the rotation direction of the pivoting gear 24; and
a pair of rotating shafts 31 being rotatably installed to the tilting body 1 and having a upper gear 26 engaged with a teethed portion 25a of the teethed slots 25 and a lower gear 30a, 30b engaged with intermediate gears 27a, 27b installed to both sides of the tilting body 1, while engaged with the pivoting gear 24 when the pivoting plate 23 is pivoted, respectively.

2. The apparatus as in claim 1, the gear train 8 includes a worm gear 7 mounted to a shaft of the driving motor 6, a helical gear 21 engaged with the worm gear, and a small gear 22 formed integrally with the helical gear 21 and engaged with the pivoting gear 24.

3. The apparatus as in claim 1, the pivoting plate 23 has a bent piece 29 being guided along an arc guide slot 28 formed at the tilting body 1.

4. The apparatus as in claim 1, the teethed portion 25a is only formed at an inside edge of the teeth slot 25.

5. The apparatus as in claim 1, the guide rails 4 have a protector 15 made from synthetic resin at front end thereof, respectively.

6. An apparatus for receiving a television or a navigator display monitor for vehicles, in which a liquid crystal monitor is ejected/received from/into a case 2 in slide manner while is tilted in horizontal direction when the monitor is ejected from the case 2, the apparatus comprises:
a chassis panel 5 being connected to a monitor cover frame 3 to which a monitor cover is mounted and having a pair of L shaped teethed slots 17 having teethed edge 17a and a plurality of support and guide slots 54, 51, 20a, 50b, the monitor cover having straight portions connected to guide rails of the case in straight line when the monitor cover frame is disposed horizontally;
a tilting body 1 having a plurality of pins 53, 49a, 49b, 52 supported at several points and guided by the support and guide slots 13, 19, 24a, 24b and being pivoted about imaginary centers C, C′ when the tilting body is tilting by driving of a driving motor provided inside thereof; and
a pair of clutch mechanisms 41 including a lower clutch shaft 43b driven by the driving motor 16, an upper clutch shafts 43b having upper gears 42a, 42b engaged with the teethed edges 25a and frictionally coupled to the lower clutch shaft 43a, and a spring 48 for pressing the lower clutch shaft 43a against the upper clutch shaft 43b, respectively;
wherein the upper gears 42a, 42b of clutch mechanisms rotate in a same direction.

7. The apparatus as in claim 6, the lower clutch shaft 43a has serration grooves 47a formed at an upper surface thereof, the upper clutch shaft 43b has serration grooves 47b frictionally coupled to the serration grooves 47a of the lower clutch shaft by the spring, at lower surface thereof.

8. The apparatus as in claim 6, the support and guide slot 54 is positioned at central portion of the chassis panel 5 and is formed V-shape of which each side has a certain curvature.

9. The apparatus as in claim 6, the teethed portions 25a are only formed at an outside edge of the teeth slots 25.
